(19) United States
(12) Patent Application Publication
(10) Pub. No.: US 2023/0111677 A1
(43) Pub. Date: Apr. 13, 2023

(54) PRODUCTION METHOD FOR GRAPHITE SHEET, AND POLYIMIDE FILM FOR GRAPHITE SHEET

(71) Applicant: KANEKA CORPORATION, Osaka (JP)

(72) Inventors: Motoaki KOBAYASHI, Settsu-shi (JP); Keisuke INABA, Settsu-shi (JP); Masashi OZAKI, Settsu-shi (JP); Teruo MATSUTANI, Settsu-shi (JP)

(73) Assignee: KANEKA CORPORATION, Osaka (JP)

(21) Appl. No.: 18/065,034

(22) Filed: Dec. 13, 2022

Related U.S. Application Data
(63) Continuation of application No. PCT/JP2021/025895, filed on Jul. 9, 2021.

(30) Foreign Application Priority Data
Jul. 9, 2020 (JP) 2020-118400

(51) Int. Cl. C08J 5/18; C08K 3/32; C08K 5/18; C01B 32/205

(52) U.S. Cl. CPC C08J 5/18; C08K 3/32; C08K 5/18; C01B 32/205; C08J 2379/08; C08K 2003/325

(57) ABSTRACT

An object is to provide, with high productivity, a graphite sheet having good thermal diffusivity and interlaminar strength. The object is attained by a method for producing a graphite sheet having a thermal diffusivity of not less than 10.0 cm²/s, the method including the step of heat-treating a polyimide film to a temperature of not lower than 2,800° C., the polyimide film containing: not less than 0.01% by weight and not more than 0.08% by weight of inorganic particles; and a non-metal additive containing not less than 0.018% by weight and not more than 0.032% by weight of phosphorus.

### TECHNICAL FIELD

The present invention relates to a method for producing a graphite sheet and to a polyimide film for the graphite sheet.

### BACKGROUND ART

Graphite sheets have excellent heat dissipation characteristics and thus are used as heat dissipating components in semiconductor devices included in various electronic devices such as computers or various electric devices, in some other heat generating components, and the like.

Such a graphite sheet can be obtained by firing a polyimide film. For example, Patent Literature 1 discloses a technique of producing a graphite sheet by firing a polyimide film that contains inorganic particles.

### CITATION LIST

### Patent Literature

[Patent Literature 1]
Japanese Patent Application Publication Tokukai No. 2014-136721

### SUMMARY OF INVENTION

### Technical Problem

Various known graphite sheets have room for improvement in order to obtain a graphite sheet that exhibits both good thermal diffusivity and good interlaminar strength. In particular, in an attempt to obtain a graphite sheet having high thermal diffusivity, the production method disclosed in Patent Literature 1 has a problem of low productivity due to defective products resulting from low interlaminar strength and fusion of a film with itself or fusion between films in a graphitization step. This problem was newly discovered by the inventors of the present invention.

It is an object of an aspect of the present invention to provide: a method for producing a graphite sheet having high thermal diffusivity and improved interlaminar strength, the method being for producing a good graphite sheet with high productivity by preventing fusion of a film during graphitization; and a polyimide film for the graphite sheet.

### Solution to Problem

In order to solve the foregoing problem, the inventors of the present invention conducted diligent study and, as a result, discovered that using, as a raw material, a polyimide film which contains inorganic particles and a phosphorus-containing non-metal additive and in which a content of the inorganic particles and a total phosphorus content are within predetermined ranges enables a graphite sheet to have high thermal diffusivity and improved interlaminar strength and enables prevention of fusion of a film with itself or fusion between films during graphitization for the graphite sheet, so that the graphite sheet can be produced with high productivity. On the basis of the finding, the inventors completed the present invention. The present invention encompasses the following aspects.

A method for producing a graphite sheet having a thermal diffusivity of not less than 10.0 cm²/s, the method including the step of: heat-treating a polyimide film to a temperature of not lower than 2800° C., the polyimide film containing inorganic particles and a phosphorus-containing non-metal additive, a content of the inorganic particles being not less than 0.01% by weight and not more than 0.08% by weight, a total phosphorus content in the inorganic particles and the phosphorus-containing non-metal additive being not less than 0.018% by weight and not more than 0.032% by weight.

A polyimide film for a graphite sheet, containing: inorganic particles; and a phosphorus-containing non-metal additive,

a content of the inorganic particles being not less than 0.01% by weight and not more than 0.08% by weight,

a total phosphorus content in the inorganic particles and the phosphorus-containing non-metal additive being not less than 0.018% by weight and not more than 0.032% by weight.

### Advantageous Effects of Invention

An aspect of the present invention makes it possible to provide, with high productivity, a graphite sheet having good thermal diffusivity and interlaminar strength.

### BRIEF DESCRIPTION OF DRAWINGS

FIG. 1 is a schematic view of a continuous carbonization step and a continuous carbonization device in accordance with an embodiment of the present invention.

FIG. 2 illustrates an example of how to set a film in a graphitization step.

### DESCRIPTION OF EMBODIMENTS

The following description will discuss embodiments of the present invention. The present invention is not, however, limited to these embodiments. The present invention is not limited to the configurations described below, but may be altered in various ways within the scope of the claims. Any embodiment or Example derived by combining technical means disclosed in differing embodiments and Examples is also encompassed in the technical scope of the present invention. All academic and patent documents cited in the present specification are incorporated herein by reference. Any numerical range expressed as “A to B” in the present specification means “not less than A and not more than B” unless otherwise stated.

### 1. Technical Idea of the Present Invention

A graphite sheet obtained by the conventional graphite sheet production method disclosed in Patent Literature 1 has room for improvement in thermal diffusivity and interlaminar strength.

As such, the inventors of the present invention conducted diligent study in order to provide a method for producing a graphite sheet having excellent thermal diffusivity and interlaminar strength. As a result, the inventors of the present invention made a new finding that a graphite sheet having excellent thermal diffusivity and interlaminar strength can be provided by heat-treating a polyimide film which (i) contains, in addition to conventionally known inorganic particles, a phosphorus-containing non-metal additive and in which (ii) a content (total amount) of phosphorus in the inorganic particles and the phosphorus-containing non-metal additive is within a certain range. The inventors of the present invention also made a new finding that the method can prevent fusion of a carbonaceous film in a graphitization step and can provide a graphite sheet with high productivity.

Conventionally, a graphite sheet consisting of a polyimide film containing inorganic particles is significantly inferior in thermal diffusivity and interlaminar strength. Under the circumstances, the inventors of the present invention discovered that adding “a phosphorus-containing non-metal additive” and also setting “a total phosphorus content in inorganic particles and the phosphorus-containing non-metal additive” to be within a certain range makes it possible to provide a method for producing a graphite sheet which has excellent thermal diffusivity and interlaminar strength and during the production process of which fusion of a film can be prevented.

The reason why the above method for producing a graphite sheet can provide a graphite sheet which is excellent in thermal diffusivity and interlaminar strength is presumed by the inventors of the present invention to be as follows.

In the method for producing a graphite sheet, inorganic particles originating from a polyimide film sublime by being heated during graphitization of a carbonaceous film obtained by carbonization of the polyimide film. At this time, conventionally used inorganic particles (e.g. calcium), which have high affinity for carbon, sublimes while reacting with carbon (graphite) that forms the graphite sheet. This disturbs the orientation of graphite in the graphite sheet, and thus decreases the thermal diffusivity and interlaminar strength of the graphite sheet.

In contrast, a phosphorus-containing non-metal additive does not tend to disturb the orientation of graphite during sublimation. As a result, the orientation of the graphite is maintained. This is considered to be why the thermal diffusivity and interlaminar strength of the graphite sheet are less likely to be reduced.

### 2. Method for Producing Graphite Sheet

A method for producing a graphite sheet in accordance with an aspect of the present invention only needs to include a step of heat-treating a polyimide film to not lower than 2,800° C., the polyimide film containing inorganic particles in an amount of not less than 0.01% by weight and not more than 0.08% by weight and having a total phosphorus content of not less than 0.018% by weight and not more than 0.032% by weight. In the present specification, a “method of producing a graphite sheet in accordance with an aspect of the present invention” may be referred to as “the present production method”.

The present production method is what is known as a polymer pyrolysis method in which a polyimide film is heat-treated in an inert gas atmosphere or under reduced pressure. Specifically, a graphite sheet is produced through (i) a carbonization step of preheating a polyimide film up to a temperature of approximately 1,000° C. to prepare a carbonized polyimide film, (ii) a graphitization step of heat-treating (heating) the carbonized polyimide film, prepared through the carbonization step, up to a temperature of not lower than 2,800° C. to graphitize the carbonized polyimide film, and (iii) a compression step, which is optional, of compressing the graphitized polyimide film. The carbonization step and the graphitization step may be carried out consecutively, or may be carried out such that after the carbonization step ends, the graphitization step is carried out separately.

(Carbonization Step)

The carbonization step is a step of carbonizing a polyimide film by heat-treating the polyimide film to a temperature of approximately 1,000° C. The method of carbonizing the polyimide film in this carbonization step is not particularly limited. For example, rectangular polyimide films in a state of being stacked on top of each other may be carbonized, a polyimide film in a roll form may be carbonized as it is in the roll form, or a polyimide film in a roll form may be continuously carbonized while being unwound. In particular, the continuous carbonization method, in which a polyimide film in a roll form is continuously carbonized while being unwound, is preferable due to having excellent productivity. The carbonization step is carried out under reduced pressure or in an inert gas, and nitrogen is preferably used as the inert gas. In the present specification, a carbonized polyimide film obtained by the carbonization step may be referred to as a carbonaceous film.

(Graphitization Step)

The graphitization step is a step of heat-treating the carbonaceous film, which has been obtained by the carbonization step, to a temperature of not lower than 2,800° C. to graphitize the carbonaceous film. In other words, the graphitization step is a step of heat-treating the carbonaceous film to obtain a graphite sheet. In the graphitization step, a temperature (maximum temperature) at which the carbonaceous film obtained by the carbonization step is heat-treated is, for example, preferably not lower than 2,800° C., not lower than 2,900° C., or not lower than 3,000° C. The upper limit is not particularly limited, but is preferably not higher than 3,300° C., and more preferably not higher than 3,200° C. In the graphitization step, in a case where the temperature (maximum temperature) at which the carbonaceous film obtained by the carbonization step is heat-treated is not lower than 2,800° C., there is an advantage that the resultant graphite sheet has good thermal diffusivity, and in a case where the temperature is not lower than 3,300° C., there is an advantage that sublimation of a graphite member in a graphitization furnace can be reduced. The graphitization step is carried out under reduced pressure or in an inert gas, and argon or helium is preferably used as the inert gas.

In the graphitization step, rectangular carbonaceous films in a state of being stacked on top of each other may be graphitized, a carbonaceous film in a roll form may be graphitized as it is in the roll form, or a carbonaceous film in a roll form may be continuously graphitized while being unwound. In terms of obtaining a long film, the method in which a carbonaceous film in a roll form is graphitized as it is in the roll form, or the method in which a carbonaceous film in a roll form is continuously graphitized while being unwound, is preferable.

(Compression Step)

The graphite sheet expanded in the graphitization step can be subjected to a compression step. Subjecting the graphite sheet to a compression step enables the graphite sheet to have plasticity. The compression step can be carried out by use of, for example, a method of planarly compressing the graphite sheet or a method of rolling the graphite sheet with use of a metallic roller or the like. The compression step can be carried out at a room temperature or can be alternatively carried out during the graphitization step. The compress step can also be referred to as a plasticizing step.

### 3. Graphite Sheet

A graphite sheet obtained by the present production method has a thermal diffusivity of preferably not less than 10.0 cm²/s, more preferably not less than 10.4 cm²/s, and even more preferably not less than 10.8 cm²/s.

A graphite sheet in accordance with an embodiment of the present invention has an interlaminar strength of preferably not less than 35 gf/inch, more preferably not less than 40 gf/inch, and even more preferably not less than 45 gf/inch. These ranges are preferable because, when a release film of a double-sided tape attached to the graphite sheet having an interlaminar strength within any of these ranges is peeled, no delamination, which can cause a decrease in thermal diffusivity of the graphite sheet, occurs.

A graphite sheet in accordance with an embodiment of the present invention has a thickness of preferably 16 μm to 85 μm, more preferably 16 μm to 80 μm, even more preferably 23 μm to 60 μm, and still even more preferably 30 μm to 50 μm. In a case where the graphite sheet has a thickness within any of these ranges, there is an advantage, for example, that the graphite sheet exhibits an excellent heat dissipation effect when used in a thin electronic device (e.g. high-function smartphone).

The thickness of a graphite sheet in accordance with an embodiment of the present invention has a lower limit that is preferably not less than 16 μm, more preferably not less than 20 μm, even more preferably not less than 23 μm, and still even more preferably not less than 30 μm. The thickness of the graphite sheet has an upper limit that is preferably not more than 85 μm, more preferably not more than 80 μm, even more preferably not more than 60 μm, and still even more preferably not more than 50 μm. In a case where the graphite sheet has a thickness of not less than 16 μm, there is an advantage that the graphite sheet exhibits a heat dissipation effect sufficient for enabling heat dissipation of an electronic device. In a case where the graphite sheet has a thickness of not more than 85 μm, there is an advantage that the graphite sheet can be provided, for example, inside a thin electronic device having limited space.

A graphite sheet in accordance with an embodiment of the present invention has a density of preferably not less than 1.80 g/cm³, more preferably not less than 2.00 g/cm³, even more preferably not less than 2.05 g/cm³, still even more preferably not less than 2.10 g/cm³, and still even more preferably not less than 2.15 g/cm³. The upper limit of the density is not particularly defined, but a typical upper limit of the density of a graphite sheet is not more than 2.26 g/cm³. In a case where the graphite sheet has a density within any of these ranges, there is an advantage that the graphite sheet exhibits an excellent heat dissipation effect.

### 4. Polyimide Film for Graphite Sheet

The following description will discuss, in detail, a polyimide film that can be used in an embodiment of the present invention. The polyimide film for a graphite sheet used in the present production method is made from an acid dianhydride component and a diamine component and contains a predetermined amount of inorganic particles and a predetermined amount of phosphorus.

(Inorganic Particles)

In a polyimide film in accordance with an embodiment of the present invention, the content of inorganic particles has a lower limit that is preferably 0.01% by weight, more preferably 0.02% by weight, and even more preferably 0.03% by weight. The content of the inorganic particles has an upper limit that is preferably 0.10% by weight, more preferably 0.08% by weight, even more preferably 0.06% by weight, and particularly preferably 0.05% by weight. Within these ranges, the ultimately obtained graphite sheet is excellent in both of the physical properties of thermal diffusivity and interlaminar strength, and has good conveyability. In a case where the content of the inorganic particles in the polyimide film is not less than 0.01% by weight, the polyimide film has excellent conveyability. This eliminates the risk of breakage of the polyimide film in the production process (for example, in the carbonization step). In a case where the content of the inorganic particles in the polyimide film is less than 0.10% by weight, the ultimately obtained graphite sheet has excellent thermal diffusivity.

Examples of inorganic particles that can be used in an embodiment of the present invention include calcium carbonate (CaCO₃), silica, calcium hydrogen phosphate (CaHPO₄), and calcium phosphate (Ca₂P₂O₇). Among these inorganic particles, inorganic particles containing phosphorus, such as calcium hydrogen phosphate or calcium phosphate, is preferable due to enabling a reduction in amount of a phosphorus-containing non-metal additive (described later) and making it easier for the graphite sheet to achieve both thermal diffusivity and interlaminar strength.

(Phosphorus-Containing Non-Metal Additive)

A polyimide film in accordance with an embodiment of the present invention preferably contains a phosphorus-containing non-metal additive such that a total phosphorus content (described later) in the inorganic particles and the phosphorus-containing non-metal additive is within a preferable range. Examples of the phosphorus-containing non-metal additive that can be used in an embodiment of the present invention include phosphate esters, phosphine oxides, phosphite esters, phosphines, phosphonate esters, phosphinate esters, pyrophosphoric acid, metaphosphoric acid, and red phosphorous. Among these examples, organic phosphorus compounds such as phosphate esters, phosphine oxides, phosphite esters, phosphines, phosphonate esters, and phosphinate esters is preferable due to being stable with respect to polyamic acid and polyimide. From the perspective of stability, the organic phosphorus compound preferably contains, as a main component, pentavalent phosphorus. In a case where a polyimide film in accordance with an embodiment of the present invention contains a phosphorus-containing non-metal additive, the polyimide film enables provision of a graphite sheet having excellent thermal diffusivity and interlaminar strength and also enables prevention of fusion of a carbonaceous film in a graphitization step. This makes it possible to provide a graphite sheet with high productivity.

The temperature at which the phosphorus-containing non-metal additive has a weight reduction rate of 5% in measurement by TG-DTA is preferably not lower than 200° C., more preferably not lower than 250° C., and even more preferably not lower than 300° C. In a case where the temperature at which the phosphorus-containing non-metal additive has a weight reduction rate of 5% is not lower than 200° C., it is possible to reduce contamination of the furnace in which the polyimide film is carbonized.

As the phosphorus-containing non-metal additive, one which has excellent compatibility with the polyimide resin is preferably used. Such an additive can be dispersed well in the polyimide film, so that a graphite sheet having less in-plane variation in expandability can be obtained.

As the phosphorus-containing non-metal additive, one which is in a liquid form at room temperature and under normal pressure is preferably used. Such an additive is not precipitated in the polyimide film, so that a graphite sheet that rarely has abnormal expansion during the graphitization can be obtained.

(Total Phosphorus Content in Inorganic Particles and Phosphorus-Containing Non-Metal Additive)

In a polyimide film in accordance with an embodiment of the present invention, the total phosphorus content in the inorganic particles and the phosphorus-containing non-metal additive has a lower limit that is more than 0.015% by weight, more preferably 0.018% by weight, even more preferably 0.021% by weight, and even more preferably 0.025% by weight. The total phosphorus content in the inorganic particles and the phosphorus-containing non-metal additive has an upper limit that is preferably 0.032% by weight, more preferably 0.031% by weight, and even more preferably 0.030% by weight. In a case where the total phosphorus content in the inorganic particles and the phosphorus-containing non-metal additive in the polyimide film is 0.018% by weight to 0.032% by weight, the ultimately obtained graphite sheet is excellent in both the physical properties of thermal diffusivity and interlaminar strength. In particular, in a case where the total phosphorus content in the inorganic particles and the phosphorus-containing non-metal additive is more than 0.015% by weight in the polyimide film, a carbonaceous film obtained by carbonizing the polyimide film has no risk of fusing with itself in the graphitization step even if the carbonaceous film is graphitized in a roll form. This allows providing a long graphite sheet. In a case where the total phosphorus content in the inorganic particles and the phosphorus-containing non-metal additive is 0.021% by weight to 0.031% by weight in the polyimide film, there is an advantage that both the physical properties of thermal diffusivity and interlaminar strength are even more excellent.

(Acid Dianhydride Component)

Examples of an acid dianhydride component that can be used as a raw material of a polyimide film in accordance with an embodiment of the present invention encompass pyromellitic dianhydride, 2,3,6,7-naphthalene tetracarboxylic dianhydride, 3,3′,4,4′-biphenyl tetracarboxylic dianhydride, 1,2,5,6-naphthalene tetracarboxylic dianhydride, 2,2′,3,3′-biphenyl tetracarboxylic dianhydride, 3,3′,4,4′-benzophenone tetracarboxylic dianhydride, 2,2-bis(3,4-dicarboxyphenyl) propane dianhydride, 3,4,9,10-perylene tetracarboxylic dianhydride, 1,1-(3,4-dicarboxyphenyl)ethane dianhydride, 1,1-bis(2,3-dicarboxyphenyl)ethane dianhydride, 1,1-bis(3,4-dicarboxyphenyl) ethane dianhydride, bis(2,3-dicarboxyphenyl)methane dianhydride, bis(3,4-dicarboxyphenyl)methane dianhydride, oxydiphthalic dianhydride, bis(3,4-dicarboxyphenyl)sulfone dianhydride, p-phenylene bis(trimellitic monoester anhydride), ethylenebis(trimellitic monoester anhydride), bisphenol A bis(trimellitic monoester anhydride), and analogues thereof. As the acid dianhydride component, these dianhydrides can be used alone, or a plurality of types of these dianhydrides can be mixed at a given ratio. Among these acid dianhydrides, it is preferable to use pyromellitic dianhydride or 3,3′,4,4′-biphenyltetracarboxylic dianhydride. Use of these acid dianhydride components allows the ultimately obtained graphite sheet to have good thermal diffusivity.

(Diamine Component)

Examples of a diamine component that can be used as a raw material of a polyimide film in accordance with an embodiment of the present invention encompass 4,4′-diaminodiphenyl ether, p-phenylenediamine, 4,4′-diaminodiphenyl methane, benzidine, 3,3′-dichlorobenzidine, 4,4′-diaminodiphenyl sulfide, 3,3′-diaminodiphenyl sulfone, 4,4′-diaminodiphenyl sulfone, 3,3′-diaminodiphenyl ether, 3,4′-diaminodiphenyl ether, 1,5-diaminonaphthalene, 4,4′-diaminodiphenyldiethyl silane, 4,4′-diaminodiphenyl silane, 4,4′-diaminodiphenyl ethyl phosphine oxide, 4,4′-diaminodiphenyl N-methylamine, 4,4′-diaminodiphenyl N-phenylamine, 1,3-diaminobenzene, 1,2-diaminobenzene, and analogues thereof. Each of these substances can be mixed at a given ratio. In particular, it is preferable to use 4,4′-diaminodiphenyl ether or p-phenylenediamine. Use of these diamine components allows the ultimately obtained graphite sheet to have good thermal diffusivity.

As raw materials of a polyimide film in accordance with an embodiment of the present invention, it is preferable to use a combination of: pyromellitic dianhydride; and 4,4′-diaminodiphenyl ether and/or p-phenylenediamine. This configuration has an advantage of excellent film formability of the polyimide film.

(Thickness of Polyimide Film)

A polyimide film in accordance with an embodiment of the present invention has a thickness of preferably 37 μm to 160 μm, more preferably 37 μm to 150 μm, even more preferably 50 μm to 125 μm, and still even more preferably 62 μm to 100 μm. In a case where the thickness of the polyimide film is within these ranges, it is possible to obtain a graphite sheet that exhibits both good thermal diffusivity and good interlaminar strength.

The thickness of a polyimide film in accordance with an embodiment of the present invention has a lower limit that is preferably not less than 37 μm, more preferably not less than 50 μm, and even more preferably not less than 62 μm. The thickness of the polyimide film has an upper limit that is preferably not more than 160 μm, more preferably not more than 150 μm, even more preferably not more than 125 μm, and still even more preferably not more than 100 μm. In a case where the thickness of the polyimide film is not less than 37 μm, there is an advantage that the polyimide film has excellent interlaminar strength. In a case where the thickness of the polyimide film is not more than 160 μm, there is an advantage that the polyimide film enables excellent thermal diffusivity to be exhibited.

(Method of Producing Polyimide Film)

A polyimide film in accordance with an embodiment of the present invention can be produced by imidization (imide conversion) of a polyamic acid which serves as a precursor. In the method for producing a polyimide film, any one of the following methods, for example, can be employed as a method for imidizing a polyamic acid which serves as a precursor: (i) a thermal cure method in which imide conversion from a polyamic acid, which serves as a precursor, is carried out by heating the polyamic acid; and (ii) a chemical cure method in which imide conversion from a polyamic acid, which serves as a precursor, is carried out with use of (a) a dehydrator typified by acid anhydride such as acetic anhydride and/or (b) an imidization accelerator typified by tertiary amines such as picoline, quinoline, isoquinoline, and pyridine. In a case where the chemical cure method is used, the imidization accelerator is preferably any of the tertiary amines described above.

The Chemical Cure Method is Particularly Preferable

because a resultant film (i) is likely to have a low linear expansion coefficient, a high elastic modulus, and a great birefringence and (ii) is capable of being rapidly graphitized at a comparatively low temperature so that it is possible to obtain a graphite sheet having good quality. In addition, it is particularly preferable to combine the dehydrator and the imidization accelerator because in such a case, a resultant film can have a lower linear expansion coefficient, a greater elastic modulus, and a greater birefringence. In the chemical cure method, imidization reaction more rapidly proceeds, so that it is possible to briefly complete the imidization reaction during heat treatment. Therefore, the chemical cure method is a productively excellent and industrially advantageous method.

(Method for producing polyamic acid) A method of producing the polyamic acid is not particularly limited. The polyamic acid can be produced by, for example, (i) dissolving, in an organic solvent, aromatic acid dianhydride and diamine which are substantially equal to each other in molar quantity and (ii) stirring the organic solvent under a controlled temperature condition until polymerization of the aromatic acid dianhydride and the diamine is completed. The method of polymerization is not particularly limited, but is preferably selected from, for example, the following methods (1) through (5). In the present specification, “substantially equal to each other in molar quantity” means that a ratio of two or more differing types of substances in molar quantity is within a range of 100:98 to 100:102.

(1) A method in which aromatic diamine is (i) dissolved in an organic polar solvent and (ii) reacted with aromatic tetracarboxylic dianhydride, which is substantially equal in molar quantity to the aromatic diamine, so that the aromatic diamine and the aromatic tetracarboxylic dianhydride are polymerized.

(2) A method in which (i) in an organic polar solvent, aromatic tetracarboxylic acid dianhydride is reacted with an aromatic diamine compound, having fewer moles than the aromatic tetracarboxylic acid dianhydride, so as to obtain a prepolymer having acid anhydride groups at its both terminals and then (ii) the prepolymer and an aromatic diamine compound, substantially equal in molar quantity to the aromatic tetracarboxylic acid dianhydride, are polymerized.

Specific examples of the above method (2) include a method of synthesizing a polyamic acid by (i) synthesizing, with use of diamine and acid dianhydride, a prepolymer having the acid dianhydride at its both terminals and (ii) reacting the prepolymer with diamine different in type from or identical in type to the diamine that has been used to synthesize the prepolymer. Also in the method (2), the aromatic diamine to be reacted with the prepolymer can be aromatic diamine different in type from or identical in type to the aromatic diamine that has been used to synthesize the prepolymer.

(3) A method in which (i) in an organic polar solvent, aromatic tetracarboxylic acid dianhydride is reacted with an aromatic diamine compound, having more moles than the aromatic tetracarboxylic acid dianhydride, so as to obtain a prepolymer having amino groups at its both terminals, (ii) an aromatic diamine compound is further added to the prepolymer, and then (iii) the prepolymer and aromatic tetracarboxylic acid dianhydride are polymerized so that the aromatic tetracarboxylic acid dianhydride is substantially equal in molar quantity to the aromatic diamine compound.

(4) A method in which (i) aromatic tetracarboxylic acid dianhydride is dissolved and/or dispersed in an organic polar solvent, (ii) an aromatic diamine compound is added to the organic polar solvent so that the aromatic diamine compound is substantially equal in molar quantity to the aromatic tetracarboxylic acid dianhydride, and then (iii) the aromatic tetracarboxylic acid dianhydride and the aromatic diamine compound are polymerized.

(5) A method in which, in an organic polar solvent, a mixture, of aromatic tetracarboxylic acid dianhydride and aromatic diamine which are substantially equal in molar quantity to each other, is reacted so as to be polymerized.

An embodiment of the present invention may be arranged as follows.

[1] A method for producing a graphite sheet having a thermal diffusivity of not less than 10.0 cm²/s, the method including the step of: heat-treating a polyimide film to a temperature of not lower than 2,800° C., the polyimide film containing inorganic particles and a phosphorus-containing non-metal additive, a content of the inorganic particles being not less than 0.01% by weight and not more than 0.08% by weight, a total phosphorus content in the inorganic particles and the phosphorus-containing non-metal additive being not less than 0.018% by weight and not more than 0.032% by weight.

[2] The method as set forth in [1], wherein the inorganic particles are calcium hydrogen phosphate or calcium phosphate.

[3] The method as set forth in [1] or [2], wherein the phosphorus-containing non-metal additive is an organic phosphorus compound.

[4] The method as set forth in [3], wherein a valency of phosphorus in the organic phosphorus compound is five.

[5] The method as set forth in any one of [1] through [4], wherein a temperature at which the phosphorus-containing non-metal additive has a weight reduction rate of 5% in measurement by TG-DTA is not lower than 200° C.

[6] The method as set forth in any one of [1] through [5], wherein the graphite sheet is graphitized in a roll form.

[7] The method as set forth in any one of [1] through [6], wherein the polyimide film has a thickness of 37 μm to 160 μm.

[8] The method as set forth in any one of [1] through [7], wherein the polyimide film contains 4,4′-diaminodiphenyl ether.

[9] The method as set forth in any one of [1] through [8], wherein the graphite sheet has a thickness of 16 μm to 85 μm.

[10] The method as set forth in any one of [1] through [9], wherein a total phosphorus content in the inorganic particles and the phosphorus-containing non-metal additive is not less than 0.021% by weight and not more than 0.031% by weight.

[11] A polyimide film for a graphite sheet, containing: inorganic particles; and a phosphorus-containing non-metal additive, a content of the inorganic particles being not less than 0.01% by weight and not more than 0.08% by weight, a total phosphorus content in the inorganic particles and the phosphorus-containing non-metal additive being not less than 0.018% by weight and not more than 0.032% by weight.

[12] The polyimide film as set forth in [11], wherein the inorganic particles are calcium hydrogen phosphate or calcium phosphate.

[13] The polyimide film as set forth in [11] or [12], wherein the phosphorus-containing non-metal additive is an organic phosphorus compound.

[14] The polyimide film as set forth in [13], wherein a valency of phosphorus in the organic phosphorus compound is five.

[15] The polyimide film as set forth in any one of [11] through [14], wherein a temperature at which the phosphorus-containing non-metal additive has a weight reduction rate of 5% in measurement by TG-DTA is not lower than 200° C.

[16] The polyimide film as set forth in any one of [11] through [15], having a thickness of 37 μm to 160 μm.

[17] The polyimide film as set forth in any one of [11] through [16], containing 4,4′-diaminodiphenyl ether.

[18] The polyimide film as set forth in any one of [11] through [17], wherein a total phosphorus content in the inorganic particles and the phosphorus-containing non-metal additive is not less than 0.021% by weight and not more than 0.031% by weight.

The following description will discuss embodiments of the present invention in further detail on the basis of Examples. However, the present invention is not limited to these Examples.

### EXAMPLES

<Phosphorus Content in Polyimide Film>

A wavelength-dispersive X-ray fluorescence analyzer (ZSX PrimusII, manufactured by Rigaku Corporation) was used to determine a phosphorus content in a polyimide film in terms of a percentage with respect to a phosphorus content in a polyimide film whose phosphorus concentration is known.

<Conveyability of Polyimide Film>

Conveyability of a polyimide film was evaluated on the basis of whether or not an abnormality was observed in the polyimide film in a continuous carbonization step described in Examples (described later).

The evaluation of conveyability of the polyimide film was based on the following criteria.

A: No problem was observed in handleability, appearance, and the like.
B: The film had no appearance problem and could be handled, although static electricity caused the film to stick to itself.
C: The film could be handled although fine scratches and creases were formed in the film during conveyance of the film.
D: Large creases and scratches were formed in the film during conveyance of the film, and a breakage occurred in the film during carbonization.

<Contamination of Continuous Carbonization Furnace>

Contamination of a continuous carbonization furnace was evaluated with respect to a degree of contamination of the continuous carbonization furnace in a continuous carbonization step described in Examples (described later).

The evaluation of contamination of the continuous carbonization furnace was based on the following criteria.

A: Hardly any dirt was observed on the continuous carbonization furnace.
B: Easily removable dirt adhered to the continuous carbonization furnace.
C: Dirt removable with use of an organic solvent adhered to the continuous carbonization furnace.
D: Dirt accumulated to form fine scratches on the film during the continuous carbonization.

<Fusion of Film in Graphitization Step>

Fusion of a film in a graphitization step was evaluated with respect to a film after a graphitization step described in Examples (described later), in terms of a degree to which the film was fused with itself while being would up.

The evaluation of fusion of a film in the graphitization step was based on the following criteria.

A: No fusion was observed.
B: A portion of the film was fused, but the fused portion was easily peeled off when the film was wound up.
C: The film had a fused portion, which had to be manually peeled off because continuous winding of the film caused the film to tear.
D: The film was firmly fused, and an attempt to manually peel off the fused portion caused the film to tear.

<Thermal Diffusivity of Graphite Sheet in Planar Direction)

Thermal diffusivity of a graphite sheet in a planar direction thereof was determined by subjecting a sample in a shape of 30 mm×30 mm cut out from the graphite sheet to measurement with use of “Thermowave Analyzer TA3” available from BETHEL Co., Ltd. in an atmosphere with a temperature of 25° C. and at a frequency of 100 Hz. Note that the sample was obtained by punching out a hole in a central portion of the sheet. Note here that the “central portion” indicates a portion located at the middle in both of width and longitudinal directions of the obtained graphite sheet.

<Interlaminar Strength of Graphite Sheet>

Interlaminar strength of the graphite sheet was determined as follows. A double-sided tape was attached to both surfaces of the obtained graphite sheet, and a sample having a size of 25 mm×80 mm was punched out from a central portion of the graphite sheet. One side of the sample was fixed to a plate made of SUS, and a double-sided tape on the opposite side was peeled off while an angle of 90° was maintained between the double-sided tape and the sample. At this time, a force exerted when peeling occurred inside the graphite sheet was measured using a digital force gauge (ZTS-5N, manufactured by IMADA CO., LTD.) and regarded as an interlaminar strength of the graphite sheet.

(Density of Graphite Sheet)

A sample having a size of a 50 millimeters square was punched out from a central portion of the obtained graphite sheet. A weight, area, and thickness of the sample were then measured. Based on a value of the weight thus measured, a density of the graphite sheet was calculated in accordance with the following formula: (a density of the graphite sheet)=(a weight of the sample)/{(an area of the sample)×(a thickness of the sample)}.

<Thickness of Graphite Sheet>

Thicknesses at four corners and a center of the obtained graphite sheet were measured with use of a micrometer manufactured by Mitutoyo Corp. Note here that the “center” indicates a position of an intersection of (i) a line via which two of the four corners of the obtained graphite sheet, which two are diagonally located, are connected and (ii) a line via which the other two of the four corners of the obtained graphite sheet, which two are diagonally located, are connected. Then, an average value of the thicknesses thus measured was regarded as a thickness of the graphite sheet.

### Example 1

<Method of Producing Polyimide Film>

Into a dimethylformamide solution in which 75 mol % of 4,4′-diaminodiphenyl ether (ODA) had been dissolved, 100 mol % of pyromellitic dianhydride (PMDA) was dissolved and then 25 mol % of p-phenylenediamine (PDA) was dissolved to obtain a polyamic acid solution containing 18.5% by weight of polyamic acid. To the obtained polyamic acid solution, calcium hydrogen phosphate was added such that the calcium hydrogen phosphate was contained at a concentration of 0.04% by weight relative to a solid content of the polyamic acid. While this solution was being cooled, an imidization catalyst, which contained acetic anhydride, isoquinoline, dimethylformamide, and resorcinol bis(diphenyl phosphate) in an amount of 0.32% by weight with respect to a solid content of the polyamic acid, was added to the solution, and the solution was defoamed. Each of the acetic anhydride and the isoquinoline was in an amount of 1 (one) equivalent with respect to a carboxylic acid group contained in the polyamic acid. Thus obtained was a mixed solution. Note that the resorcinol bis(diphenyl phosphate) thus used had a phosphorus content of 10.5% by weight and a 5% weight reduction temperature in TG-DTA of 261° C.

This mixed solution was then applied onto an aluminum foil to obtain a mixed solution layer that would have a thickness of 75 μm after being dried. The mixed solution layer on the aluminum foil was dried with use of a hot-air oven and a far-infrared heater.

Specifically, the drying was carried out in the following manner. First, the mixed solution layer on the aluminum foil was dried at 120° C. for 240 seconds in the hot-air oven so as to obtain a gel film having a self-supporting property. The gel film was then removed from the aluminum foil and was fixed to a frame. Thereafter, the gel film was dried by being heated in stages, that is, by being heated at 120° C. for 30 seconds, at 275° C. for 40 seconds, at 400° C. for 42 seconds, and at 450° C. for 50 seconds in the hot-air oven and then being heated at 460° C. for 22 seconds with use of a far-infrared heater. Note that part of the resorcinol bis(diphenyl phosphate) was volatilized during the drying (during film formation). Through this operation, obtained was a polyimide film (A-1) which had a calcium hydrogen phosphate content of 0.04% by weight, a resorcinol bis(diphenyl phosphate) content of 0.21% by weight, a total phosphorus content of 0.032% by weight, and a thickness of 75 μm.

(Method for Producing Graphite Sheet)

A polyimide film (A-1) in the form of a roll and having a thickness of 75 μm, a width of 250 mm, and a length of 300 m was set on an unwinding side of a device for conveying a film, and was subjected to a continuous carbonization step while the polyimide film was continuously moved into a heat treatment device.

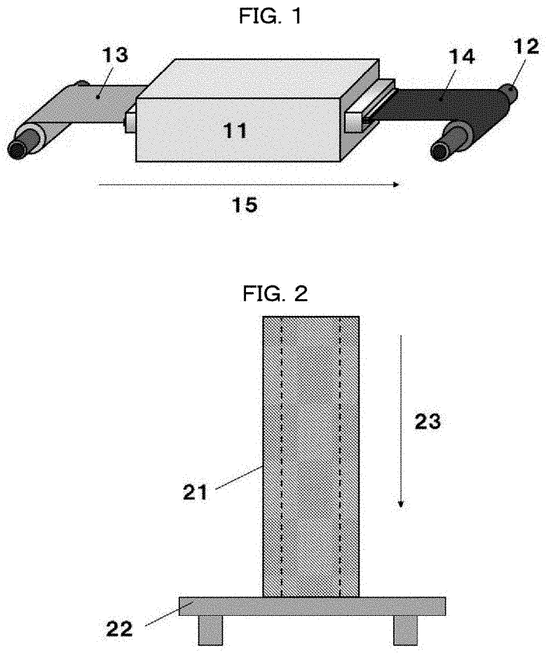

The continuous carbonization step was carried out using the continuous carbonization device as illustrated in FIG. 1. The continuous carbonization device is a device in which a device 12 for carrying a polyimide film 13 is combined with a heat treatment device 11 including an inlet, an outlet, and heating chambers, and by which a carbonaceous film 14 is continuously obtained by subjecting the polyimide film 13 to a heat treatment (carbonization step) in the heat treatment device 11. The heat treatment device 11 included six heating chambers in the machine direction. Each of the heating chambers had a dimension of 500 mm in the machine direction and a dimension of 300 mm in the transverse direction. Gas in each of the heating chambers was replaced with nitrogen so that the heating chambers were under flow of a nitrogen atmosphere (2 L/min). The temperatures set in the heating chambers were adjusted to 600° C., 615° C., 630° C., 645° C., 670° C., and 720° C., respectively. In the continuous carbonization step, the film (the polyimide film 13 and the carbonaceous film 14) was conveyed in a conveyance direction 15 at a speed adjusted to 1.6 m/min and with a tension of 10 N exerted on the film. In the heating chambers of the heat treatment device 11, the film was sandwiched from above and below by expanded graphite sheets (thermal conductivity: 200 W/m, thickness: 400 μm), which were members inside a furnace. Note that the members inside the furnace were provide so as to be in contact with the film. In the continuous carbonization step, the film was conveyed so as to slide on the members inside the furnace. The members inside the furnace were provided so as to cover an area larger than an area in which the film passed inside the heating chambers.

Next, the carbonaceous film 14 after the continuous carbonization step was cooled down to room temperature (23° C.), and was turned into a roll form having an inner diameter of 100 mm. Thus obtained was a roll 21 of the carbonaceous film illustrated in FIG. 2. The roll 21 of the carbonaceous film was set on a bottom 22 of the furnace such that the width direction of the film extended vertically as illustrated in FIG. 2, and a graphitization step was carried out at a heating rate of 1° C./min up to a temperature of 3,100° C. In FIG. 2, an arrow 23 indicates the direction of gravitational force.

Then, the film after the graphitization step was cooled down to room temperature (23° C.), and the graphitized film was subjected to a compression step (plasticizing step) at the room temperature (23° C.) under a pressure of 10 MPa. Thus obtained was a graphite sheet. The graphite sheet after the compression was subjected to the foregoing tests to examine the characteristics of the graphite sheet.

### Examples 2 to 10 and Comparative Examples 1 to 5

A polyimide film was produced in a similar manner to Example 1, except that calcium hydrogen phosphate and resorcinol bis(diphenyl phosphate) were added in respective amounts indicated in Table 1. A graphite sheet was produced with use of the polyimide film.

### Example 11

A polyimide film having a resorcinol bis(diphenyl phosphate) content of 0.21% by weight, a total phosphorus content of 0.022% by weight, and a thickness of 75 μm was produced in a similar manner to Example 1, except that calcium carbonate was used in place of calcium hydrogen phosphate. A graphite sheet was produced with use of the polyimide film.

### Example 12

A polyimide film having a resorcinol bis(diphenyl phosphate) content of 0.21% by weight, a total phosphorus content of 0.022% by weight, and a thickness of 75 μm was produced in a similar manner to Example 1, except that silica was used in place of calcium hydrogen phosphate. A graphite sheet was produced with use of the polyimide film.

### Example 13

A polyimide film having a resorcinol bis(diphenyl phosphate) content of 0.11% by weight, a total phosphorus content of 0.020% by weight, and a thickness of 75 μm was produced in a similar manner to Example 3, except that calcium phosphate was used in place of calcium hydrogen phosphate. A graphite sheet was produced with use of the polyimide film.

### Example 14

A polyimide film having a triphenyl phosphate content of 0.13% by weight, a total phosphorus content of 0.022% by weight, and a thickness of 75 μm was produced in a similar manner to Example 1, except that 0.49% by weight of triphenyl phosphate (phosphorus content: 9.5% by weight, 5% weight reduction temperature in TG-DTA: 220° C.) was added in place of resorcinol bis(diphenyl phosphate). A graphite sheet was produced with use of the polyimide film.

### Example 15

A polyimide film having a triphenylphosphine oxide content of 0.11% by weight, a total phosphorus content of 0.022% by weight, and a thickness of 75 μm was produced in a similar manner to Example 1, except that 0.30% by weight of triphenylphosphine oxide (phosphorus content: 11.1% by weight, 5% weight reduction temperature in TG-DTA: 243° C.) was added in place of resorcinol bis(diphenyl phosphate). A graphite sheet was produced with use of the polyimide film.

### Example 16

A polyimide film having a biphenol bis(diphenyl phosphate) content of 0.13% by weight, a total phosphorus content of 0.022% by weight, and a thickness of 75 μm was produced in a similar manner to Example 1, except that 0.15% by weight of biphenol bis(diphenyl phosphate) (phosphorus content: 9.5% by weight, 5% weight reduction temperature in TG-DTA: 395° C.) was added in place of resorcinol bis(diphenyl phosphate). A graphite sheet was produced with use of the polyimide film.

### Examples 17 to 20

A polyimide film was produced in a similar manner to Example 1, except that the polyimide film had a thickness indicated in Table 1. A graphite sheet was produced with use of the polyimide film. Note that a film formation time for the polyimide film and a heat-up time in the graphitization step were such that a firing time was adjusted in proportion to the thickness. For example, a firing time set for a film having a thickness of 50 μm was shorter, by half, than a firing time set for a film having a thickness of 100 μm.

Table 1 shows production conditions and physical properties of graphite sheets in accordance with Examples 1 to 20 and Comparative Examples 1 to 5.

TABLE 1

| | Polyimide film | | | | | | | | |
|---|---|---|---|---|---|---|---|---|---|
| | | | | | | Temperature at | Amount of | | |
| | | | Amount of | | | which phosphorus | phosphorus | Phosphorus | Total |
| | | Type of | inorganic | Type of | Phosphorus | additive has | additive | additive | phosphorus |
| | Thickness | inorganic | particles | phosphorus | content in | weight reduction | added | content | content |
| | (μm) | particles | (wt %) | additive | additive | rate of 5% | (wt %) | (wt %) | (wt %) |
| Example 1 | 75 | CaHPO₄ | 0.04 | Resorcinol | 10.5% | 261° C. | 0.32 | 0.21 | 0.032 |
| | | | | bis(diphenyl | | | | | |
| | | | | phosphate) | | | | | |
| Example 2 | 75 | CaHPO4 | 0.04 | ↑ | 10.5% | 261° C. | 0.25 | 0.16 | 0.027 |
| Example 3 | 75 | CaHPO4 | 0.04 | ↑ | 10.5% | 261° C. | 0.18 | 0.11 | 0.022 |
| Example 4 | 75 | CaHPO4 | 0.04 | ↑ | 10.5% | 261° C. | 0.12 | 0.08 | 0.018 |
| Example 5 | 75 | CaHPO4 | 0.06 | ↑ | 10.5% | 261° C. | 0.23 | 0.15 | 0.031 |
| Example 6 | 75 | CaHPO4 | 0.06 | ↑ | 10.5% | 261° C. | 0.16 | 0.10 | 0.026 |
| Example 7 | 75 | CaHPO4 | 0.06 | ↑ | 10.5% | 261° C. | 0.09 | 0.06 | 0.021 |
| Example 8 | 75 | CaHPO4 | 0.02 | ↑ | 10.5% | 261° C. | 0.32 | 0.21 | 0.027 |
| Example 9 | 75 | CaHPO4 | 0.02 | ↑ | 10.5% | 261° C. | 0.25 | 0.16 | 0.022 |
| Example 10 | 75 | CaHPO4 | 0.02 | ↑ | 10.5% | 261° C. | 0.19 | 0.12 | 0.018 |
| Comp. | 75 | CaHPO4 | 0.10 | — | — | | — | — | 0.025 |
| Example 1 | | | | | | | | | |
| Comp. | 75 | CaHPO4 | 0.06 | — | — | | — | — | 0.015 |
| Example 2 | | | | | | | | | |
| Comp. | 75 | CaHPO4 | 0.04 | — | — | | — | — | 0.010 |
| Example 3 | | | | | | | | | |
| Comp. | 75 | CaHPO4 | 0.02 | — | — | | — | — | 0.005 |
| Example 4 | | | | | | | | | |
| Comp. | 75 | — | 0.00 | Resorcinol | 10.5% | 261° C. | 0.32 | 0.21 | 0.022 |
| Example 5 | | | | bis(diphenyl | | | | | |
| | | | | phosphate) | | | | | |
| Example 11 | 75 | CaCO3 | 0.04 | ↑ | 10.5% | 261° C. | 0.32 | 0.21 | 0.022 |
| Example 12 | 75 | SiO2 | 0.04 | ↑ | 10.5% | 261° C. | 0.32 | 0.21 | 0.022 |
| Example 13 | 75 | Ca3(PO4)2 | 0.04 | ↑ | 10.5% | 261° C. | 0.18 | 0.11 | 0.020 |
| Example 14 | 75 | CaHPO4 | 0.04 | Triphenyl | 9.5% | 220° C. | 0.49 | 0.13 | 0.022 |
| | | | | phosphate | | | | | |
| Example 15 | 75 | CaHPO4 | 0.04 | Triphenyl- | 11.1% | 243° C. | 0.30 | 0.11 | 0.022 |
| | | | | phosphine | | | | | |
| | | | | oxide | | | | | |
| Example 16 | 75 | CaHPO4 | 0.04 | Biphenol | 9.5% | 395° C. | 0.15 | 0.13 | 0.022 |
| | | | | bis(diphenyl | | | | | |
| | | | | phosphate) | | | | | |
| Example 17 | 125 | CaHPO4 | 0.04 | Resorcinol | 10.5% | 261° C. | 0.18 | 0.11 | 0.022 |
| | | | | bis(diphenyl | | | | | |
| | | | | phosphate) | | | | | |
| Example 18 | 100 | CaHPO4 | 0.04 | ↑ | 10.5% | 261° C. | 0.18 | 0.11 | 0.022 |
| Example 19 | 62 | CaHPO4 | 0.04 | ↑ | 10.5% | 261° C. | 0.18 | 0.11 | 0.022 |
| Example 20 | 50 | CaHPO4 | 0.04 | ↑ | 10.5% | 261° C. | 0.18 | 0.11 | 0.022 |

| | Suitability for steps | | | | | |
|---|---|---|---|---|---|---|
| | | Contamination | | Physical properties of graphite sheet | | |
| | | of continuous | | Thermal | Interlaminar | |
| | PI | carbonization | Fusion during | diffusivity | strength | Density |
| | transportability | furnace | graphitization | (cm²/s) | (gf/inch) | (g/cm3) |
| Example 1 | B | D | A | 10.4 | 55 | 2.11 |
| Example 2 | B | C | B | 10.5 | 47 | 2.13 |
| Example 3 | B | B | B | 10.6 | 41 | 2.15 |
| Example 4 | B | B | C | 10.6 | 37 | 2.16 |
| Example 5 | A | C | A | 10.0 | 59 | 2.10 |
| Example 6 | A | B | B | 10.0 | 50 | 2.12 |
| Example 7 | A | B | B | 10.1 | 46 | 2.14 |
| Example 8 | C | D | B | 10.7 | 43 | 2.14 |
| Example 9 | C | C | B | 10.8 | 39 | 2.16 |
| Example 10 | C | B | C | 10.8 | 35 | 2.17 |
| Comp. | A | A | B | 9.6 | 60 | 2.10 |
| Example 1 | | | | | | |
| Comp. | A | A | D | 10.1 | 41 | 2.15 |
| Example 2 | | | | | | |
| Comp. | B | A | D | 10.7 | 30 | 2.17 |
| Example 3 | | | | | | |
| Comp. | C | A | D | 10.9 | 28 | 2.18 |
| Example 4 | | | | | | |
| Comp. | D | — | — | — | — | 2.17 |
| Example 5 | | | | | | |
| Example 11 | B | D | B | 10.4 | 40 | 2.10 |
| Example 12 | B | D | B | 10.1 | 47 | 2.10 |
| Example 13 | B | B | B | 10.5 | 42 | 2.16 |
| Example 14 | B | C | B | 10.6 | 45 | 2.15 |
| Example 15 | B | C | B | 10.7 | 47 | 2.15 |
| Example 16 | B | A | B | 10.6 | 44 | 2.15 |
| Example 17 | A | B | A | 10.0 | 68 | 1.97 |
| Example 18 | B | B | A | 10.2 | 61 | 2.03 |
| Example 19 | C | B | B | 10.6 | 39 | 2.15 |
| Example 20 | C | B | C | 10.8 | 36 | 2.17 |

As indicated in Examples 1 to 20, graphite sheets each obtained from a polyimide film having an inorganic particle content of not less than 0.01% by weight and not more than 0.08% by weight and a phosphorus content of not less than 0.018% by weight and not more than 0.032% by weight was excellent in both the physical properties of thermal diffusivity and interlaminar strength, and had an improvement in fusion of the film with itself in the graphitization step. As indicated in Comparative Example 1, a graphite sheet obtained from a polyimide film having an inorganic particle content of not less than 0.10% by weight had high interlaminar strength and no significant problem in terms of fusion of the film with itself in the graphitization step, but had poor thermal diffusivity. As indicated in Comparative Examples 2 to 4, graphite sheets each obtained from a polyimide film having a phosphorus content of not more than 0.015% by weight was not in a great length because the film was fused with itself in the graphitization step and a breakage occurred in the film when the film was peeled. Further, as indicated in Comparative Example 5, a polyimide film having an inorganic particle content of less than 0.01% by weight had poor conveyability and had a breakage in the continuous carbonization step, so that it was not possible to obtain a graphite sheet from the polyimide film.

### INDUSTRIAL APPLICABILITY

A graphite sheet obtained in an embodiment of the present invention is produced with excellent productivity due to less fusion of a film with itself or fusion between films in a graphitization step and has good thermal diffusivity and interlaminar strength. As such, the graphite sheet can be suitably used as a heat dissipation member of an electronic device.

1. A method for producing a graphite sheet having a thermal diffusivity of not less than 10.0 cm²/s, the method comprising:
heat-treating a polyimide film to a temperature of not lower than 2,800° C., the polyimide film containing inorganic particles and a phosphorus-containing non-metal additive, a content of the inorganic particles being from 0.01% by weight to 0.08% by weight, and a total phosphorus content in the inorganic particles and the phosphorus-containing non-metal additive being from 0.018% by weight to 0.032% by weight.

2. The method as set forth in claim 1, wherein the inorganic particles are calcium hydrogen phosphate or calcium phosphate.

3. The method as set forth in claim 1, wherein the phosphorus-containing non-metal additive is an organic phosphorus compound.

4. The method as set forth in claim 3, wherein a valency of phosphorus in the organic phosphorus compound is five.

5. The method as set forth in claim 1, wherein a temperature at which the phosphorus-containing non-metal additive has a weight reduction rate of 5% in measurement by TG-DTA is not lower than 200° C.

6. The method as set forth in claim 1, wherein the graphite sheet is graphitized in a roll form.

7. The method as set forth in claim 1, wherein the polyimide film has a thickness of 37 μm to 160 μm.

8. The method as set forth in claim 1, wherein the polyimide film contains 4,4′-diaminodiphenyl ether.

9. The method as set forth in claim 1, wherein the graphite sheet has a thickness of 16 μm to 85 μm.

10. The method as set forth in claim 1, wherein a total phosphorus content in the inorganic particles and the phosphorus-containing non-metal additive is from 0.021% by weight to 0.031% by weight.

11. A polyimide film for a graphite sheet, comprising:
inorganic particles; and
a phosphorus-containing non-metal additive,
a content of the inorganic particles being from 0.01% by weight to 0.08% by weight, and
a total phosphorus content in the inorganic particles and the phosphorus-containing non-metal additive being from 0.018% by weight to 0.032% by weight.

12. The polyimide film as set forth in claim 11, wherein the inorganic particles are calcium hydrogen phosphate or calcium phosphate.

13. The polyimide film as set forth in claim 11, wherein the phosphorus-containing non-metal additive is an organic phosphorus compound.

14. The polyimide film as set forth in claim 13, wherein a valency of phosphorus in the organic phosphorus compound is five.

15. The polyimide film as set forth in claim 11, wherein a temperature at which the phosphorus-containing non-metal additive has a weight reduction rate of 5% in measurement by TG-DTA is not lower than 200° C.

16. The polyimide film as set forth in claim 11, having a thickness of 37 μm to 160 μm.

17. The polyimide film as set forth in claim 11, containing 4,4′-diaminodiphenyl ether.

18. The polyimide film as set forth in claim 11, wherein a total phosphorus content in the inorganic particles and the phosphorus-containing non-metal additive is from 0.021% by weight to 0.031% by weight.

19. The method as set forth in claim 2, wherein the phosphorus-containing non-metal additive is an organic phosphorus compound.

20. The polyimide film as set forth in claim 12, wherein the phosphorus-containing non-metal additive is an organic phosphorus compound.
